(19) United States
(12) Patent Application Publication
(10) Pub. No.: US 2003/0115214 A1
(43) Pub. Date: Jun. 19, 2003

(54) Medical reporting system and method

(76) Inventors: Nir Essar, Ramat Gan (IL); Merav Barkavi-Shani, (US); Doram Sobol, (US)

Correspondence Address: NIR ESSAR, 110 ALVF DAVID ST., RAMAT GAN, IL

(21) Appl. No.: 10/015,557

(22) Filed: Dec. 17, 2001

(51) Int. Cl. G06F 7/00

(52) U.S. Cl. 707/104.1

(57) ABSTRACT

A medical reporting system comprising a distributed system including a patient part, a database computer and a doctor's part, and communication means attached to each part of the distributed system for transferring data or voice therebetween. A distributed medical reporting system comprising a central database, connected through communication means to a hub for medical measurement devices. A medical reporting method comprising the steps of: A. creating a patient record, by a doctor recording the data in a system's central database; B. recording a specific medical questionnaire to his/hers patient, relevant to the patient's problem, by the doctor; C. providing the patient with a phone number for calling the medical reporting system, for answering the doctor's questionnaire; D. calling the medical reporting system by the patient, and answering by speaking into the phone to voice questions presented by the system; E. recording the patient's voice answers at the medical reporting system; and F. reporting to the doctor the recorded patient's voice answers.

### STATEMENT AS TO RIGHTS TO INVENTIONS MADE UNDER FEDERALLY SPONSORED R&D

There was no Federal sponsoring for the present invention. There are no rights deriving therefrom.

### FIELD OF THE INVENTION

This invention relates to medical reporting systems, and more particularly to a medical database system and method for reporting voice and other patient's responses.

### BACKGROUND OF THE INVENTION

At present, databases usually store textual or graphic information, that is entered by the system's operator.

Other database systems may store voice recordings, or may forward the recordings to an addressee designated by a user.

A doctor or therapist usually meets a patient personally. This is a relatively costly and time consuming treatment. The patient has to travel, sometimes to a far away location in order to meet the doctor. The doctor has to meet the patient at a predefined time, whereas it may be convenient for him/her to treat the patient at some other time.

Present recording systems usually employ written forms. Such forms may be difficult to fill for some patients, especially where the patient is at a remote location or in an emergency.

The patient usually has limited access to the reporting system, thus it may be difficult for him/her to contact a doctor in time.

Systems using written forms are difficult to use as real time, interactive systems.

In such prior art systems, it may be difficult for the physician to leave messages and/or specific instructions for the patient. The therapist may encounter difficulty in responding to what the patient has actually said.

Manual systems using written forms are difficult to adapt to computer database systems, thus depriving the user from the various benefits available in such computerized systems.

It may be desirable to assist the physician in his/her decision-making, by providing him/her with the relevant information. Such information may include both patient's personal reports, and readings from medical instruments which measure patient's body functions. Such integrated systems apparently are not presently available.

It is an objective of the present invention to overcome the abovedetailed problems in medical treatment, using a reporting database.

### SUMMARY OF THE INVENTION

According to the present invention, there is provided a medical reporting system with means for voice recording, analysis and forwarding.

According to one aspect of the invention, a medical reporting system includes a distributed medical database. The distributed system includes a patient part, a database computer or mainframe and a doctor's part, wherein each part may be at a different location.

According to another aspect of the invention, the medical reporting system uses an effective communication protocol to collect information from medical measurement devices and to bring the information to the doctor.

According to yet another aspect of the invention, the medical reporting method is based on a dual database. The database includes both recorded voice and computer data such as text, figures and/or graphs.

Furthermore, the new system and method can be used for integrating data gathered from medical measurement devices (MMDs) used by the patients at home, with audio data gathered from the patients through the CTI sub-system, using interactive voice questionnaires, matching the needs of the attending doctor.

The information is stored in one database, so the doctor can retrieve the information in a format most suitable to him/her.

Further objects, advantages and other features of the present invention will become obvious to those skilled in the art upon reading the disclosure set forth hereinafter.

### BRIEF DESCRIPTION OF THE DRAWINGS

FIG. 1 Distributed medical database system

FIG. 2 Communications protocol hub/MMD—for medical instrument

FIG. 3 Communications protocol hub/database

FIG. 4 Database computer

FIG. 5 Patient's record in dual database

### DETAILED DESCRIPTION OF THE PREFERRED EMBODIMENTS

A preferred embodiment of the present invention will now be described by way of example and with reference to the accompanying drawings.

Abbreviations

| | |
|---|---|
| CPU | central processing Unit |
| CRC | cyclic redundancy code ? |
| ID | identification |
| IR | infrared |
| MMD | medical measurement device |
| OCR | optical character reader |
| POTS | plain old telephone system |

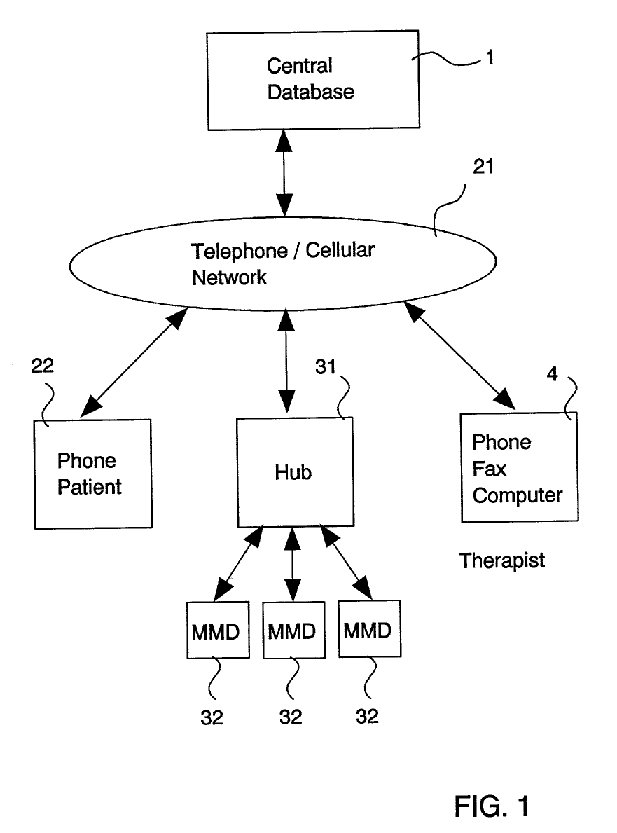

Referring to FIG. 1, a distributed medical database system comprises a central database 1, connected through a telephone/cellular network 21 to a phone (patient) 22, a hub 31 for medical measurement devices and a phone/fax/computer 4 at therapist facilities. Device 22 may include other communication means in lieu of the phone.

In a minimal embodiment of the distributed medical reporting system, the central database is located at the doctor's facilities and is connected through communication means to a hub for medical measurement devices for a patient at a remote location. More complex systems use a database that is separate from the doctor's location, and may service several doctors and/or patients.

The database 1 preferably includes the means for handling large amounts of information, including audio (voice) files. It also includes interfaces to the PSTN, cellular networks, the Internet, and/or other dedicated networks. Preferably, a modular structure allows its adaptation to future needs.

An actual system may include a plurality of phones 22, as well as units 4, to facilitate its connection to a plurality of patients and doctors.

The hub 31 connects a MMD 32 (medical measurement device or instrument) to the database. It may connect a plurality of such instruments, according to doctor's instructions. The hub is a device that can gather data from all kinds of MMDs through IR or USB interfaces and transmit it to the system's central database.

The transmission can be performed immediately in real time, or at a later time.

Preferably, the hub 31 also includes a real time clock, and the hub attaches a time stamp to each instrument recording. That is, each measurement also includes an indication regarding the time when it has been taken.

If the measurement is transmitted in real time, the time stamp may be attached at the database 1, however if there is a time delay between measurement and transmission, it is preferable to use a time base in the hub itself.

As an alternative, the communication device 22 or the medical instruments may provide a time stamp indication.

The system can be used for integrating data gathered from medical measurement devices (MMDs) used by the patients at home, with audio data gathered from the patients through the CTI sub-system, using interactive voice questionnaires, matching the needs of the attending doctor.

The information is stored in one database, so the doctor can retrieve the information in a format most suitable to him/her.

The system aims to replace written forms with voice reports or forms. This is a novel method for data acquisition, that can replace the traditional method that uses written forms. Voice is a natural, basic means of human communications.

One benefit of voice reporting is its effective use in an emergency. A caller can access the system from anywhere, using a regular phone or a cellular phone, for example.

Another benefit is its use as a real time, interactive system. Moreover, the system can call back the patient. The system also enables the physician to leave messages and/or specific instructions for the patient.

The therapist can also respond to what the patient has said.

The system offers the benefits of a database system. Furthermore, it provides additional information that is not available in prior art systems, such as the option to hear the patient's voice, to review a graph of the patient's vocal stress and/or to view graphic/statistical analysis.

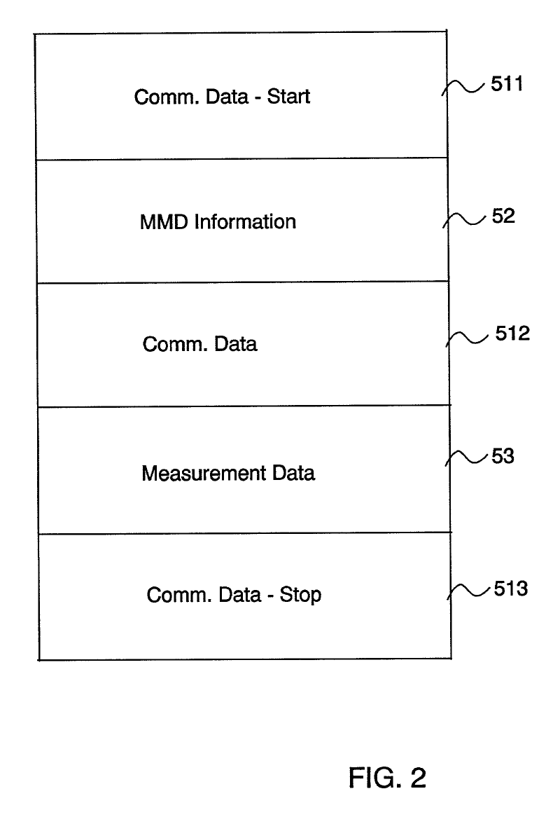

FIG. 2 illustrates a communications protocol between the hub and MMD—for transferring medical instrument data. A transmitted block may include:

a. communications-related data 511, for example start bits

b. MMD-related information 52, that may include, for example:

Bits representing the MMD code—each such device would have its own particular code.

Bits representing the manufacturer code.

Bits representing manufacturer specific information—each manufacturer will be able to define this part according to its own needs.

c. communications-related data 512, for example CRC

d. measurement data 53. Empty bits may be filled with zeros, ones or other predefined combination

The measurement data may also include a time stamp information, that may include the time and date of a patient body function measurement.

e. other communications-related data 513—stop bits, CRC

The above elements can be used to implement a communications protocol for medical measurement data. This can be a proprietary or public, protocol specifically designed for the purpose of medical measurement data transmission. It defines the structure of the data transferred from the MMDs to the Hub, and from the Hub to the central database.

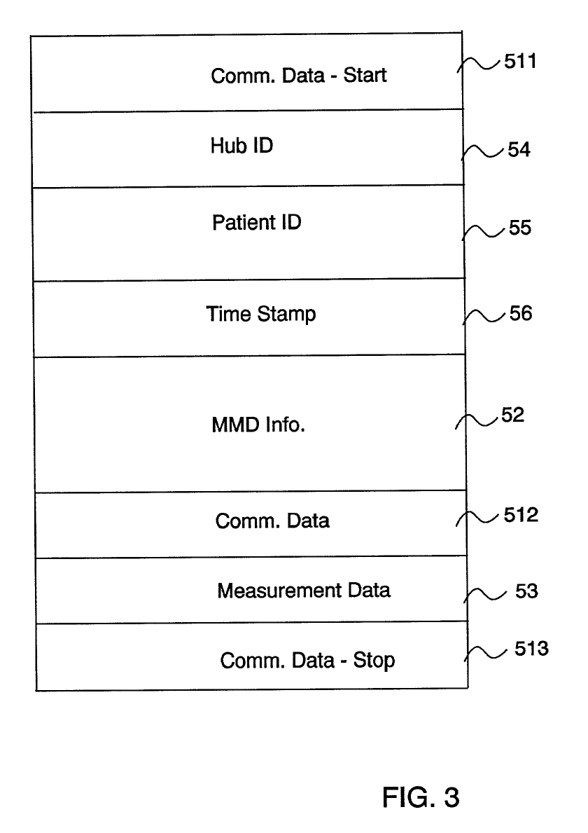

FIG. 3 illustrates a communications protocol between hub and database. In one embodiment, a transmitted block may include:

a. communications-related data 511—start bits

b. Hub ID 54—each Hub may have its own particular ID number

c. patient ID 55. It can be defined by hub ID 54 or a different value. In the former case, each ID 54 is associated with the patient ID 55 in the central database.

d. timestamp 56. It may be important to know when the measurement has been taken. The time stamp 56 may include the time and date.

e. MMD-related information 52, which may include:

Bits representing the MMD code—each such device would have its own particular code.

Bits representing the manufacturer code.

Bits representing manufacturer specific information—each manufacturer will be able to define this part according to its own needs.

f. communications-related data 512—start bits, stop bits, CRC,

g. measurement data 53—empty bits may be filled with zeros, ones or other predefined combination

g. communications-related data 513—stop bits, CRC,

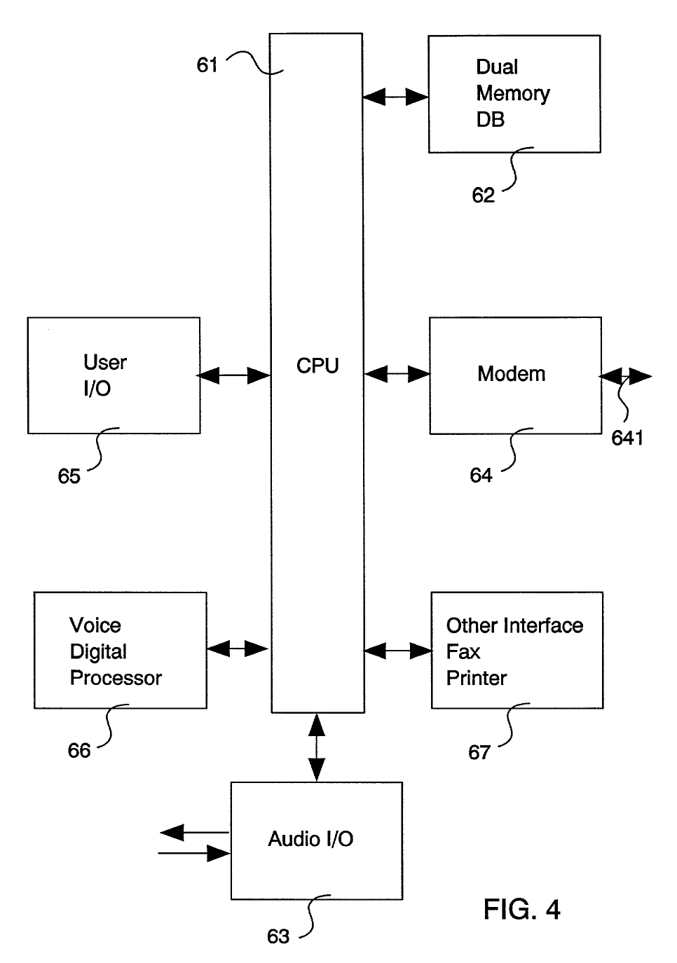

FIG. 4 illustrates a database computer. The computer may include:

a. a CPU 61, for performing the various tasks in the computer

b. a dual memory 62, that is a large digital memory. It may include magnetic memory means (disks), optical memory (CDs), etc.

c. audio card 63 one or more audio bidirectional channel cards, for voice input/output. Used for local recording or playback of voice messages

d. modem 64 line communications means, for data comm with wireline or wireless channels 641

e. local user interface means 65 may include keyboard, display, mouse, graphic input device, audio input/output means (local) such as microphone and loudspeaker and electronic interface means therefor.

f. voice digital processor 66

g. other interface means 67 may include fax, printer, OCR, etc.

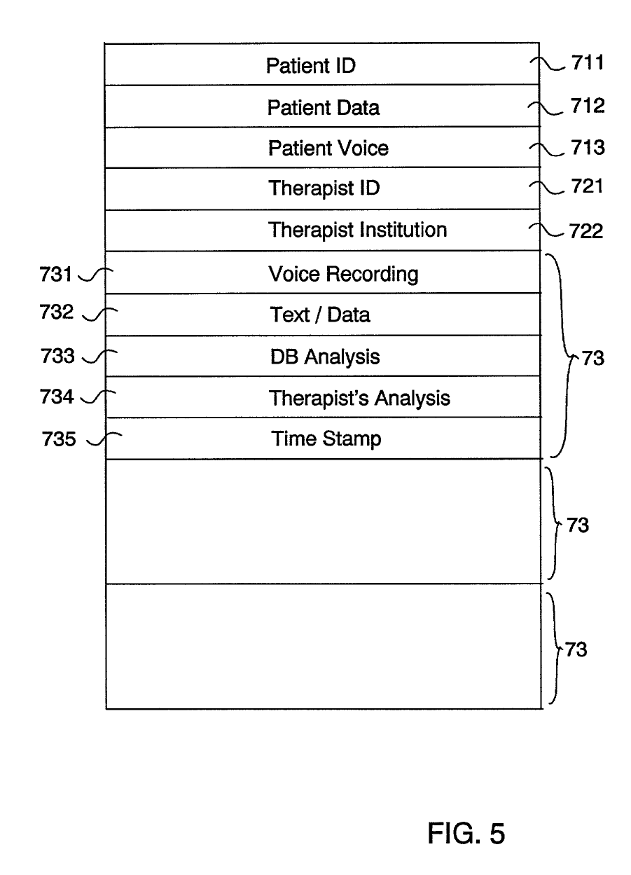

FIG. 5 illustrates a patient record in the dual database. It may include:

a. Patient ID 711

b. patient data 712

c. reference voice recording 713

d. therapist ID 721

e. therapist institution/hospital ID 722

f. patient recording 73, plurality of, including

g. voice recording 731

h. text/data recording 732

i. database analysis/recommendations 733

j. therapist's analysis/recommendations 734

k. time stamp 735

Method of Operation

1. The doctor calls the system using a regular analogue telephone, a cellular phone or the Internet, and creates a patient record, (providing he passed the access control and authentication sub-systems), by recording the data in the system's central database.

2. The doctor proceeds to recording a specific medical questionnaire to his/hers patient relevant to the patient's problem. These questionnaires been proven to be effective throughout the years and are being used in many fields of medicine: Psychology, Cardiology, Asthma, Diabetes etc. (See attached examples of such questionnaires).

3. The patient receives a special phone number to which he can call whenever he has something to report (according to the doctor's specifications). In addition to that, he also receives a Hub that will enable the transmission of the data from the MMD utilized in the case to the central database.

4. The patient calls the above phone number, answering naturally (by speaking into the phone) to voice questions presented by the system. If the patient is connected to medical instruments, their measurement results are transferred to the central database.

5. The system records the patient's voice answers, as well as the measurement results of the medical instruments. A textual transcription of the patient's answers is also entered into the database. The text can be provided either automatically or manually. Automatic computerized means may include voice recognition methods as known in the art. Manual methods may include human operators who can type the patient's answers into the system.

6. The system performs further analysis of the patient's answers, such as signal processing for stress analysis or variation in voice timber analysis, for example.

7. The patient's information is made available to the doctor, either when the doctor calls or on the system's initiative.

8. The system records a doctor's instructions, guidelines and/or questions, to be subsequently presented to the patient.

End of method.

Various types of a medical questionnaire can be used to probe the patient's problem. Following are examples of such questionnaires.

Asthma Patient Parent Questionnaire (APPQ)

1. How many times did you cough last night?

2. How many times did you cough during the day?

3. How many squeaking & dispnea occurrences (including respiratory distress) have you experienced? For how long and how severe were they?

4. What was the length of your best expirium, out of three breaths to the peak flow meter, in the morning?

5. What was the length of your best expirium, out of three breaths to the respirator, in the morning?

6. How many times a day has the child taken each pill?

7. Has there been any side effects today? If so, which side effects?

8. Has there been any other out-of-the-ordinary phenomenons, for example illnesses or hospitalizations, since your last report?

Behavioral Monitoring Questionnaire

1. Hello X. Could you please describe briefly what were you doing or what kept you busy just before you knew that you would like to report?

2. Can you specify the emotions involved ?

3. Can you grade them on a scale of 1-100%?

4. Did you notice any physical symptoms ? Please describe them.

5. Can you grade them on a scale of 1-100%?

6. What was your immediate interpretation?

7. How precise was your belief in it on a scale of 1-100%?

8. Well, I believe we are done with the report.

We will discuss the event in our next session.

Please call-up to report whenever you feel the situation occurs.

Goodbye.

Cognitive Monitoring Questionnaire

1. Hello X. Could you please describe briefly what were you doing or what kept you busy just before you knew that you would like to report?

2. Can you specify the emotions involved?

3. Can you grade them on a scale of 1-100%?

4. Did you notice any physical symptoms? Please describe them.

5. Can you grade them on a scale of 1-100%?

6. How long did it last?

7. How did you react to it? What did you do?

8. Well, I believe we are done with the report.

We will discuss the event in our next session.

Please call-up to report whenever you fell the situation occurs.

Goodbye.

Dietor Monitoring Questionnaire (DMQ)

1) Hello, please tell me in one sentence, how did you feel during the day?

2) Have you managed to comply with my instructions, as I have recommended?If so disregard the following four questions.

3) If you didn't take the capsules as I have told you, what did you miss and why?

4) If you didn't adhere with the with the food regiment, what body sensations, feelings, or event did cause it?

5) Which feelings occurred when you realized your missfall, what have you done and what did you think of ?

6) How did you behave afterwards?

7) I am going to receive this report and we will discuss what's relevant during our next meeting. Goodbye.

Drug Adherence Facilitator Questionnaire (DAFQ)

Reporting plan:

First 4 evenings: every day

5th to end of 2nd week: disparate days (Sunday, Tuesday, Thurshday and Saturday)

3-4th week: Tuesdays and Saturdays

The apparatus will call the patient that doesn't report until a certain hour.

Questionnaire

1. Hello, this is doctor Essar. Please tell me, did you took your medication according to my recommendations?

2. If you didn't adhere to my recommendation, what were the reasons?

3. What and how much have you taken?

4. After taking the medications, where there any side effects?

5. If so, what kind? How long did they last?

6. Since your last report, did you suffer from any new problem or have it been any worsening of symptoms?

7. Since your last report, has there been any improvement of symptoms or behavior?

The present system and method offers various advantages over prior art systems in the field of telemedicine and remote medical measurement devices, for example:

1. A prior art system monitors the patient in real-time, requiring him to carry the monitoring device on him at all times. It may be difficult to use such systems other than in hospitals. Our system is intended to be used by the patient at home (the Hub) and another part of it (the telephony part) anywhere he goes.

2. Prior art systems apparently do not deal with behavioural monitoring of a patient.

All of the systems simply monitor body functions, and transmit the data to a central station.

Our invention monitors a patient's behaviour by asking him to answer several questions by means of a telephone device of some sort (analogue, cellular or a dedicated device) and stores his answers for further analysis and review by medical personnel.

3. The new Hub we invented is a device handling medical data gathering and transmission to a central database. It does not perform the monitoring of a patient's body functions, which are implemented with existing instruments; rather, the hub's aim is to collect all such instruments' output and send it to a central database, to be gathered along with the patient's recorded answers.

4. The new system is integrative. Whereas some of its components may be known in the art, they have not hitherto been used as part of a larger system for medical data gathering.

5. Although prior art teaches of Interactive Pill Dispensers (IPD), these devices have not hitherto been integrated within a larger system for medical data gathering.

Prior art devices reviewed did not include an IR port to interface with another device (the Hub in our case), but some included a modem for the purpose of alerting a caretaker of some sort.

Method of use of IPD

Following is a description of the operation of the Interactive Pill Dispensers (IPD) as part of a larger system for medical data gathering:

1. The IPD sends information to the central database

2. the application installed on that database checks the received information and acts responsive to that information and medical instructions stored therein

3. the application installed on the database acts upon the medical personnel specifications to instruct the patient as desired. For example, the system might initiate a call to the patient, reminding him to take his medication, if he has not done so in a specified period of time.

End of method.

Optionally, the patient might be carrying a dedicated communications device (a special cellular phone) the system can call.

Various implementations of the invention will become obvious to the reader upon reading the above disclosure.

Various MMDs can be used, that measure all kinds of parameters, such as blood pressure, glucose level (diabetes), peak flow (asthma), body temperature, body weight and heart functionality.

There is also a possibility to connect pill dispensers to the system, thus monitoring the patient's medication consumption.

The Hub can be connected to any type of telecommunications network (PSTN, Cellular) and transmit the data utilizing the MMDP protocol as defined above, to the central database.

The doctor receives reports that include the patient's answers to the voice questionnaire, typed into the database by authorized, medically trained personnel, plus the measurements data from the MMDs the patient is using.

The system can call the patient in case he has not reported in a specified period of time, and also alert the doctor.

The reports can be obtained, for example, through the Internet, by facsimile or using a simple telephone device. The web interface enables the doctor access to the audio files of the answers, as well as the textualized information, plus the measurements data, and graphical analysis of it.

It will be recognized that the foregoing is but one example of an apparatus and method within the scope of the present invention and that various modifications will occur to those skilled in the art upon reading the disclosure set forth hereinbefore.

What is claimed is:

1. A medical reporting system comprising a distributed system including a patient part, a database computer and a doctor's part, and communication means attached to each part of the distributed system for transferring data or voice therebetween.

2. The medical reporting system according to claim 1, wherein the database computer includes means for voice recording, analysis and forwarding.

3. The medical reporting system according to claim 2, wherein the voice analysis means comprise voice stress analysis means.

4. The medical reporting system according to claim 1, wherein the database computer includes means for storing both recorded voice and computer data.

5. The medical reporting system according to claim 4, wherein the computer data includes text, figures and/or graphs.

6. The medical reporting system according to claim 1, wherein the database computer includes means for recording a patient's voice response to voice questions presented by the database computer.

7. The medical reporting system according to claim 1, wherein the database computer includes means for recording both voice and data gathered from medical measurement devices used by a patient.

8. The medical reporting system according to claim 1, wherein the patient part includes means for connecting to a medical instrument and for transferring information from the instrument to the communication means attached to the patient part.

9. A distributed medical reporting system comprising a central database, connected through communication means to a hub for medical measurement devices.

10. The distributed system according to claim 9, further including means for connecting the central database through communication means to reporting means at a therapist facilities.

11. The distributed system according to claim 10, wherein the reporting means at the therapist facilities comprise a phone, fax or computer.

12. The distributed system according to claim 9, wherein the communication means comprise interface means to a PSTN, a cellular network, the Internet or to a dedicated network.

13. The distributed system according to claim 9, wherein the communication means further includes communication means for connecting to a plurality of hubs for medical measurement devices.

14. A medical reporting method comprising the steps of:
A. creating a patient record, by a doctor recording the data in a system's central database;
B. recording a specific medical questionnaire to his/hers patient, relevant to the patient's problem, by the doctor;
C. providing the patient with a phone number for calling the medical reporting system, for answering the doctor's questionnaire;
D. calling the medical reporting system by the patient, and answering by speaking into the phone to voice questions presented by the system;
E. recording the patient's voice answers at the medical reporting system; and
F. reporting to the doctor the recorded patient's voice answers.
